(19) United States
(12) Patent Application Publication
(10) Pub. No.: US 2024/0330777 A1
(43) Pub. Date: Oct. 3, 2024

(54) AUTOMATED GROUP OF ASSOCIATED ALERTS

(71) Applicant: Freshworks Inc., San Mateo, CA (US)

(72) Inventors: Ashutosh DWIVEDI, Bengaluru (IN); Suryakant SINGH, Vaishali (IN); Charan KUMAR, Bengaluru (IN); Sachin ADLAKHA, Santa Clara, CA (US)

(73) Assignee: Freshworks Inc., San Mateo, CA (US)

(21) Appl. No.: 18/191,602

(22) Filed: Mar. 28, 2023

(51) Int. Cl. G06N 20/10

(52) U.S. Cl. CPC G06N 20/10

(57) ABSTRACT

Real-time automated grouping of associated alerts into a single incident uses a machine learning (ML) framework. The framework includes learning alert-vectors and a n-dimensional representation in a vector space to determine a frequency of occurrence and co-occurrence patterns of repeat data. The framework includes applying a cosine-similarity or vector similarity metrics to determine the frequency of the occurrence and co-occurrence patterns in the repeat data, and grouping the repeated data based on the learning of the learning of the alert-vectors and the n-dimensional representation and the applying of the cosine-similar or vector similarity metrics.

### FIELD

The present invention relates to machine learning (ML) based framework, and more particularly, to real-time automated grouping of associated alerts into a single incident using the ML based framework.

### BACKGROUND

The alert management system (AMS) is a module that manages alerts coming from a company's IT infrastructure. For purposes of explanation, these alerts may include alerts originating form relational databases that operate using master-slave architecture, alerts from cloud components that are directly or indirectly linked, etc. These alerts are generated by various observability tools that monitor the company's infrastructure. Often, multiple alerts from different sources are generated by monitoring tools even though there may be a single underlying problem or a failure. The various alerts potentially result in multiple incidents (or notifications) being created that are assigned to different teams for problem diagnostic and resolution. Given that there might be a single underlying issue, these independent incidents delays resolution of the problem or failure.

Most of the existing alert grouping/attachment workflows are based on static rules and/or need additional user provided information, such as network topology, to understand the relationship between the different components in the network.

Also, in a system where the IT administrators are not routing all the alerts to a central system, identifying the association between the alerts may not be feasible or practical.

Accordingly, an improved ML based framework for grouping associated alerts into a single incident may be beneficial.

### SUMMARY

Certain embodiments of the present invention may provide solutions to the problems and needs in the art that have not yet been fully identified, appreciated, or solved by current alert management system. For example, some embodiments of the present invention pertain to a ML based framework that automatically discovers associations and patterns between alerts. In one embodiment, the ML based framework looks at historical co-occurrence patterns of alerts, and learns about alerts, which typically occur within the same time window and are triggered from related or same resources. The ML based framework may then cluster the alerts together, thereby reducing noise and creating fewer incidents.

In an embodiment, a computer-implemented method for grouping two or more associated alerts includes learning, by a machine learning (ML) model, alert-vectors and a n-dimensional representation in a vector space to determine a frequency of occurrence and co-occurrence patterns of repeat data. The method also includes applying, by the ML model, a cosine-similarity or vector similarity metrics to determine the frequency of the occurrence and co-occurrence patterns in the repeat data. The method further includes grouping, by the ML model, the repeated data based on the learning of the learning of the alert-vectors and the n-dimensional representation and the applying of the cosine-similar or vector similarity metrics.

In another embodiment, a computer program is embodied on a non-transitory computer readable medium. The computer program being configured to cause at least one processor to execute learning, by a machine learning (ML) model, alert-vectors and a n-dimensional representation in a vector space to determine a frequency of occurrence and co-occurrence patterns of repeat data. The computer program is further configured to cause at least one processor to execute applying, by the ML model, a cosine-similarity or vector similarity metrics to determine the frequency of the occurrence and co-occurrence patterns in the repeat data. The computer program is further configured to cause at least one processor to execute grouping, by the ML model, the repeated data based on the learning of the learning of the alert-vectors and the n-dimensional representation and the applying of the cosine-similar or vector similarity metrics.

In yet another embodiment, an apparatus includes memory comprising a set of instructions and at least one processor. The set of instructions are configured to cause at least one processor to execute learning, by a machine learning (ML) model, alert-vectors and a n-dimensional representation in a vector space to determine a frequency of occurrence and co-occurrence patterns of repeat data. The set of instructions are further configured to cause at least one processor to execute applying, by the ML model, a cosine-similarity or vector similarity metrics to determine the frequency of the occurrence and co-occurrence patterns in the repeat data. The set of instructions are further configured to cause at least one processor to execute grouping, by the ML model, the repeated data based on the learning of the learning of the alert-vectors and the n-dimensional representation and the applying of the cosine-similar or vector similarity metrics.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 is a flow diagram illustrating a method associating co-occurring alerts, according to an embodiment of the present invention.

FIG. 2 is a diagram illustrating a technique for associating co-occurring alerts, according to an embodiment of the present invention.

FIG. 3 is a flow diagram illustrating a method for real-time automated grouping of associated alerts into a single incident using the ML based framework, according to an embodiment of the present invention.

FIG. 4 is an architectural diagram illustrating a computing system configured to real-time automated grouping of associated alerts into a single incident using the ML based framework, according to an embodiment of the present invention.

### DETAILED DESCRIPTION OF THE EMBODIMENTS

Some embodiments generally pertain to a ML based framework (or system) that uses historical co-occurrence patterns of alerts to learn, establish and quantify the association or relationship between various alerts.

### Modeling Approach

In some embodiments, the ML based framework uses co-occurrence patterns to learn alert-vectors and a n-dimensional representation in the vector space to understand how frequently the occurrence and co-occurrence patterns repeat in the data. The co-occurrence patterns of two alerts are characterized by their repeated, nearly simultaneous appearance, indicating a significant correlation between them. Alert-vectors may be defined as a numerical representation of alerts, where n numerical values are used to represent the alert. The values are chosen by an algorithm such that the computing cosine similarity of two alert representations produces a large value (e.g., [−1, 1]), if the alerts are related. N-dimensional vector space may be defined as a space that has n dimensions. This means that each vector in the space has n components, and requires n axes to represent the space. In this example, n is an hyperparameter representing numerical values in the alerts vector. Additionally, the ML based framework also applies a cosine-similarity or any other vector similarity metrics to understand how frequently the occurrence and co-occurrence patterns repeat in the data. These alert-vectors may be used for other high level tasks, such as alert-prioritization, alert auto-closure, etc.

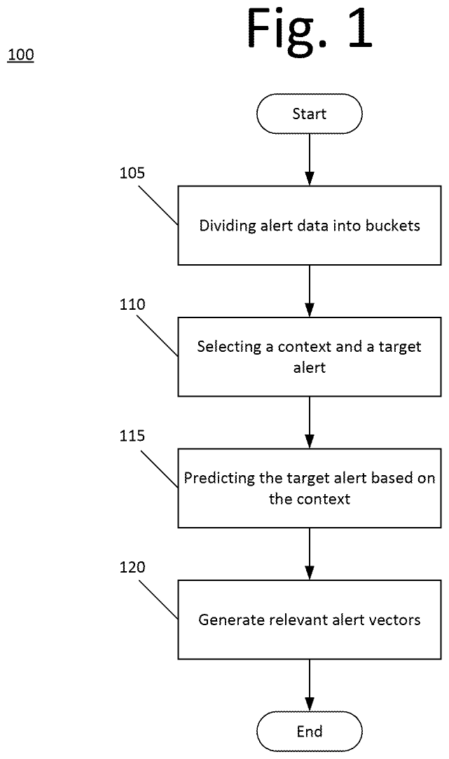

In short, some embodiments pertain to associate alerts that frequently co-occur. FIG. 1 is a flow diagram illustrating a method 100 associating co-occurring alerts, according to an embodiment of the present invention. In some embodiments, method 100 includes dividing alert data into a plurality of bucket of a configurable time window at 105. By bucketing, we mean that alerts are grouped based on their time of occurrence. To understand this process, let's imagine three alerts occurring at time t0, t1=t0+10 min, and t2=t0+15 min. In this example, if a window size of 15 mins is considered, the alert t0 and t1 are grouped under the same first bucket while alert t2 is grouped in the second bucket. In this example, there are 2 buckets with time window size of 15 min each, and there are 2 alerts and 1 alert, respectively.

At 110, method 100 includes, in each configurable time window, selecting a context and a target alert. At 115, method 100 includes predicting the target alert given the context alert. The basic idea here is that the associated alerts occur close together in time. At 120, method 100 includes generating relevant alert vectors and increasing the training process using an alert frequency based negative sampling approach.

In some embodiments, frequency based sampling means that the chances of alerts getting picked for the training sample increases with the frequency of occurrence. For example, an alert that occurred 100 times is twice as more likely to get selected (in the sample) than an alert that occurred only 50 times. The ML model is trained for every alert that requires positive samples (i.e., alert pairs that co-occurred in the same context window) and negative samples (i.e., alert pairs that do not co-occur in the same context window). In this embodiment, negative pairs selected based on their frequency of occurrence are used in the model training process.

Increasing the model training process generally means providing the ML model with more data to learn from and more iterations to fine-tune the parameters of the ML model. The goal of increasing the training process is to improve the accuracy and performance of the ML model on new data. In some embodiments, the training process is increased by increasing the size of the training dataset, and by increasing the number of iterations. Increasing the training process may result in higher computational time but will give us the desired performance.

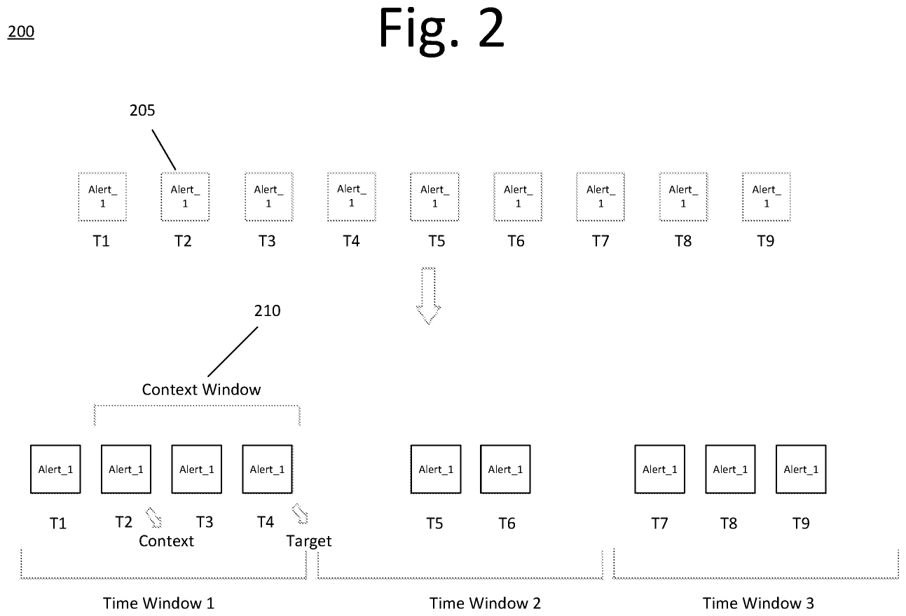

FIG. 2 is a diagram illustrating a technique 200 for associating co-occurring alerts, according to an embodiment of the present invention. Technique 200 shows that the alerts are divided into temporal buckets 205 based on the occurrence time. In each temporal bucket 205, a sliding context window 210 is considered in order to select a context alert and a target alert.

In some embodiments, given a context alert, the target alert is predicted. All alerts inside the context window form positive examples and all alerts outside the context window form negative examples. For example, in FIG. 2, in Time Window 1, alert_1 and all alerts in Time Windows 2 and 3 are outside of the context window. These alerts form a negative example.

Because the number of negative examples is large at each training step and training for each negative example is a computationally intense process, only a subset or a sample from the entire set of negative examples is used. For example, the ML model uses frequency distribution of the alerts to select this subset of negative examples.

The ML model may then optimize for the following loss function in an iterative process until the model converges. In this embodiments, convergence means that the value of the loss function remains constant for several consecutive iterations. In this example, convergence of the function implies that the alert grouping has reached an optimal steady state.

$$= argmax {\sum }_{( {a}_{i} , {a}_{p} ) ∈ P} log σ ( {v}_{{a}_{i}} \cdot {v}_{{a}_{p}} ) + {\sum }_{( {a}_{i} , {a}_{n} ) ∈ N} log σ ( {v}_{{a}_{i}} \cdot - {v}_{{a}_{n}} ) \qquad Equation ( 1 )$$

where P is a set of positive pairs (aᵢ, aₚ), which is extracted by sliding a window across time; N is a set of negative pairs (aᵢ, aₙ), which is constructed by sampling noise based on frequency; and Vax is an alert represented in the n-dimensional vector space.

### Validation

In some embodiments, the clusters generated from the above steps are used by computing noise and heterogeneity reduction achieved due to clustering. The basic idea being that accurate vector representations create more cohesive clusters, thereby lower heterogeneity at the cluster level and lower noise at the overall level. These two metrics are computed as follows:

$$Noise reduction = \frac{n - c}{n} \qquad Equation ( 2 )$$

where n is a total number of alerts and c represents the number of clusters upon convergence.

$$Heterogenecity Reduction = \frac{{\sum }_{i = 1}^{C} {\sum }_{j = 1}^{{n}_{C}} D ( {e}_{ij} , {c}_{i} )}{{\sum }_{k = 1}^{n} D ( {e}_{k} , {c}_{o} )} \qquad Equation ( 3 )$$

where n is a total number of alerts, c is a number of clusters upon convergence, n_{c} is a number of alerts in the cluster c, and D(x, y) is an Euclidean distance between points x and y.

Users may configure the thresholds for both these counter balancing metrics (noise & impurity reductions) depending on the desired quality of the output. For the automated grouping exercise, both the thresholds were set at 0.5. Simulations on sample customer accounts suggested that the approach for the set thresholds was able to achieve a 70 percent alert coverage and 50 percent incident volume reduction due to ML based framework.

### User Feedback

In some embodiments, alerts are attached to an incident based on preset thresholds for similarity scores. Further, users have the option of detaching the alerts from the incidents. This is considered to be negative feedback. Also, ML model refresh may occur periodically, which takes the negative feedback into account while defining the loss function.

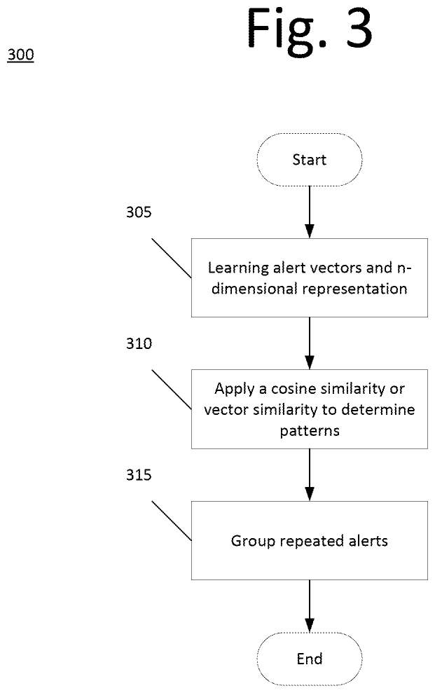

FIG. 3 is a flow diagram illustrating a method 300 for real-time automated grouping of associated alerts into a single incident using the ML based framework, according to an embodiment of the present invention. In some embodiment, method 300 includes learning, by a ML model, alert-vectors and a n-dimensional representation in a vector space to determine a frequency of occurrence and co-occurrence patterns of repeat data at 305. At 310, method 100 includes applying, by the ML model, a cosine-similarity or vector similarity metrics to determine the frequency of the occurrence and co-occurrence patterns in the repeat data. At 315, method 300 includes grouping, by the ML model, the repeated data based on the learning of the learning of the alert-vectors and the n-dimensional representation and the applying of the cosine-similar or vector similarity metrics.

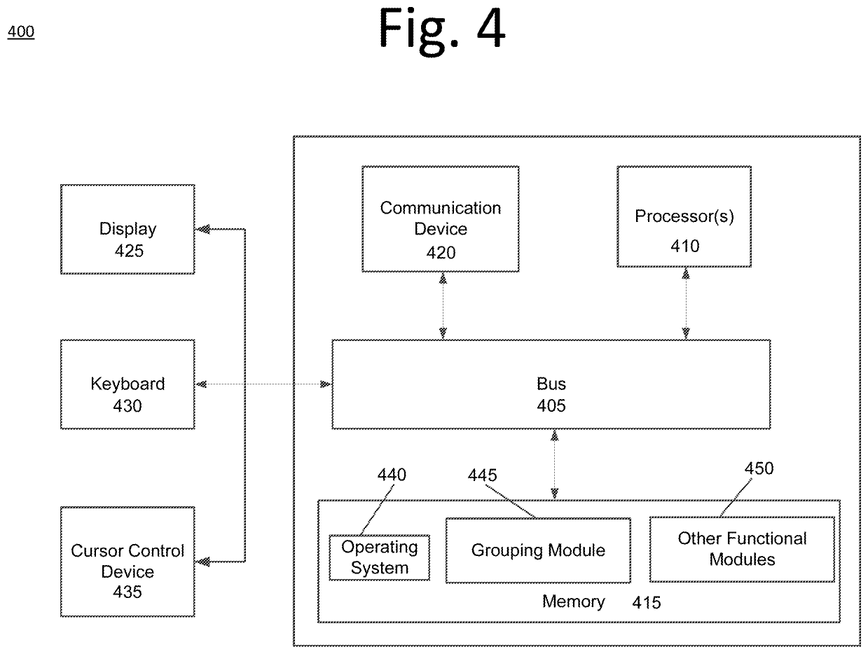

FIG. 4 is an architectural diagram illustrating a computing system 400 configured to real-time automated grouping of associated alerts into a single incident using the ML based framework, according to an embodiment of the present invention. In some embodiments, computing system 400 may be one or more of the computing systems depicted and/or described herein. Computing system 400 includes a bus 405 or other communication mechanism for communicating information, and processor(s) 410 coupled to bus 405 for processing information. Processor(s) 410 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 510 may also have multiple processing cores, and at least some of the cores may be configured to perform specific functions. Multi-parallel processing may be used in some embodiments. In certain embodiments, at least one of processor(s) 410 may be a neuromorphic circuit that includes processing elements that mimic biological neurons. In some embodiments, neuromorphic circuits may not require the typical components of a Von Neumann computing architecture.

Computing system 400 further includes a memory 415 for storing information and instructions to be executed by processor(s) 410. Memory 415 can be comprised of any combination of Random Access Memory (RAM), Read Only Memory (ROM), flash memory, cache, static storage such as a magnetic or optical disk, or any other types of non-transitory computer-readable media or combinations thereof. Non-transitory computer-readable media may be any available media that can be accessed by processor(s) 410 and may include volatile media, non-volatile media, or both. The media may also be removable, non-removable, or both.

Additionally, computing system 400 includes a communication device 420, such as a transceiver, to provide access to a communications network via a wireless and/or wired connection. In some embodiments, communication device 420 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 520 may include one or more antennas that are singular, arrayed, phased, switched, beamforming, beamsteering, a combination thereof, and or any other antenna configuration without deviating from the scope of the invention.

Processor(s) 410 are further coupled via bus 405 to a display 425, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, a 4K display, a high definition display, a Retina® display, an In-Plane Switching (IPS) display, or any other suitable display for displaying information to a user. Display 425 may be configured as a touch (haptic) display, a three dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 430 and a cursor control device 435, such as a computer mouse, a touchpad, etc., are further coupled to bus 405 to enable a user to interface with computing system. However, in certain embodiments, a physical keyboard and mouse may not be present, and the user may interact with the device solely through display 425 and/or a touchpad (not shown). Any type and combination of input devices may be used as a matter of design choice. In certain embodiments, no physical input device and/or display is present. For instance, the user may interact with computing system 400 remotely via another computing system in communication therewith, or computing system 400 may operate autonomously.

Memory 415 stores software modules that provide functionality when executed by processor(s) 410. The modules include an operating system 440 for computing system 400. The modules further include a grouping module 445 that is configured to perform all or part of the processes described herein or derivatives thereof. Computing system 400 may include one or more additional functional modules 450 that include additional functionality.

One skilled in the art will appreciate that a “system” could be embodied as a server, an embedded computing system, a personal computer, a console, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

The process steps performed in FIGS. 1 and 3 may be performed by a computer program, encoding instructions for the processor(s) to perform at least part of the process(es) described in FIGS. 1 and 3, in accordance with embodiments of the present invention. The computer program may be embodied on a non-transitory computer-readable medium. The computer-readable medium may be, but is not limited to, a hard disk drive, a flash device, RAM, a tape, and/or any other such medium or combination of media used to store data. The computer program may include encoded instructions for controlling processor(s) of a computing system (e.g., processor(s) 410 of computing system 400 of FIG. 4) to implement all or part of the process steps described in FIGS. 1 and 3, which may also be stored on the computer-readable medium.

The computer program can be implemented in hardware, software, or a hybrid implementation. The computer program can be composed of modules that are in operative communication with one another, and which are designed to pass information or instructions to display. The computer program can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A computer-implemented method for grouping two or more associated alerts, comprising:
learning, by a machine learning (ML) model, alert-vectors and a n-dimensional representation in a vector space to determine a frequency of occurrence and co-occurrence patterns of repeat data;
applying, by the ML model, a cosine-similarity or vector similarity metrics to determine the frequency of the occurrence and co-occurrence patterns in the repeat data; and
grouping, by the ML model, the repeated data based on the learning of the learning of the alert-vectors and the n-dimensional representation and the applying of the cosine-similar or vector similarity metrics.

2. The computer-implemented method of claim 1, wherein the learning of the alert-vectors and the n-dimensional representation comprising
learning, by the ML model, using co-occurrence patterns of the two or more associated alerts.

3. The computer-implemented method of claim 2, wherein the two or more associated alerts are characterized by repeated, simultaneous appearance, indicating a significant correlation between the two or more associated alerts.

4. The computer-implemented method of claim 2, wherein the alert-vectors are numerical representation of the two or more associated alerts, where n numerical values to represent the two or more associated alerts.

5. The computer-implemented method of claim 4, further comprising:
selecting the n numerical values by computing a cosine similarity of the two or more associated alerts to produce a large value when the two or more associated alerts are related.

6. The computer-implemented method of claim 2, wherein the n-dimensional vector space comprises a vector in the space having n components and n axes representing the space.

7. The computer-implemented method of claim 1, further comprising:
refreshing, by the ML model, the grouping of the repeated data when one or more associated alerts are detached from one or more incidents.

8. A computer program embodied on a non-transitory computer readable medium, the computer program being configured to cause at least one processor to execute:
learning, by a machine learning (ML) model, alert-vectors and a n-dimensional representation in a vector space to determine a frequency of occurrence and co-occurrence patterns of repeat data;
applying, by the ML model, a cosine-similarity or vector similarity metrics to determine the frequency of the occurrence and co-occurrence patterns in the repeat data; and
grouping, by the ML model, the repeated data based on the learning of the learning of the alert-vectors and the n-dimensional representation and the applying of the cosine-similar or vector similarity metrics.

9. The computer program of claim 8, wherein the computer program is further configured to cause at least one processor to execute
learning, by the ML model, using co-occurrence patterns of the two or more associated alerts.

10. The computer program of claim 9, wherein the two or more associated alerts are characterized by repeated, simultaneous appearance, indicating a significant correlation between the two or more associated alerts.

11. The computer program of claim 9, wherein the alert-vectors are numerical representation of the two or more associated alerts, where n numerical values to represent the two or more associated alerts.

12. The computer program of claim 11, wherein the computer program is further configured to cause at least one processor to execute
selecting the n numerical values by computing a cosine similarity of the two or more associated alerts to produce a large value when the two or more associated alerts are related.

13. The computer program of claim 9, wherein the n-dimensional vector space comprises a vector in the space having n components and n axes representing the space.

14. The computer program of claim 8, wherein the computer program is further configured to cause at least one processor to execute
refreshing, by the ML model, the grouping of the repeated data when one or more associated alerts are detached from one or more incidents.

15. An apparatus configured to group two or more associated alerts, comprising:
memory comprising a set of instructions; and
at least one processor, wherein
the set of instructions are configured to cause at least one processor to execute:
learning, by a machine learning (ML) model, alert-vectors and a n-dimensional representation in a vector space to determine a frequency of occurrence and co-occurrence patterns of repeat data;
applying, by the ML model, a cosine-similarity or vector similarity metrics to determine the frequency of the occurrence and co-occurrence patterns in the repeat data; and
grouping, by the ML model, the repeated data based on the learning of the learning of the alert-vectors and the n-dimensional representation and the applying of the cosine-similar or vector similarity metrics.

16. The apparatus of claim 15, wherein the set of instructions are further configured to cause at least one processor to execute
learning, by the ML model, using co-occurrence patterns of the two or more associated alerts.

17. The apparatus of claim 16, wherein the two or more associated alerts are characterized by repeated, simultaneous appearance, indicating a significant correlation between the two or more associated alerts.

18. The apparatus of claim 16, wherein the alert-vectors are numerical representation of the two or more associated alerts, where n numerical values to represent the two or more associated alerts.

19. The apparatus of claim 18, wherein the set of instructions are further configured to cause at least one processor to execute
selecting the n numerical values by computing a cosine similarity of the two or more associated alerts to produce a large value when the two or more associated alerts are related.

20. The apparatus of claim 16, wherein the n-dimensional vector space comprises a vector in the space having n components and n axes representing the space.
